(19) United States
(12) Patent Application Publication
(10) Pub. No.: US 2005/0271496 A1
(43) Pub. Date: Dec. 8, 2005

(54) Formed product and method for production thereof

(75) Inventors: Shiro Torizuka, Tsukuba-shi (JP); Kotobu Nagai, Tsukuba-shi (JP); Eijiro Muramatsu, Tsukuba-shi (JP); Yoshiyuki Suzuki, Higashiyatsushiro-gun (JP)

Correspondence Address: WENDEROTH, LIND & PONACK, L.L.P., 2033 K STREET N. W., SUITE 800, WASHINGTON, DC, 20006-1021, US

(73) Assignee: NATIONAL INSTITUTE FOR MATERIALS SCIENCE, Tsukuba-shi (JP)

(21) Appl. No.: 10/531,386

(22) PCT Filed: Oct. 17, 2003
(86) PCT No.: PCT/JP03/13309

§ 371 Date: Jul. 29, 2005

(30) Foreign Application Priority Data
Oct. 17, 2002 (JP) 2002-303660

(51) Int. Cl. F16B 35/04

(52) U.S. Cl. 411/424

(57) ABSTRACT

A formed product, characterized in that it is produced by using, as a material, a steel having an ultra fine structure comprising ferrite grains having an average grain diameter of 3 μm or less and by a method comprising only a forming step and including none of refining steps; and a method for producting the above formed product with ease. The formed product contains no alloying element and has been subjected to no refining step, and has been imparted with high strength and high toughness by the above ultra fine structure.

### TECHNICAL FIELD

The present invention relates to a formed product, and a method for production thereof. More particularly, the invention relates to a formed product ensuring high strength and high toughness by ultra fine structure without resort to addition of alloying elements or refining steps, and a method of producting the same easily.

### BACKGROUND ART

Hitherto, to product a formed product of metal or alloy, generally, a steel bar or wire is used as material, and formed in cold or warm working, and refined by hardening, carburizing or tempering. In production of formed product, however, refining by hardening and tempering is a complicated and difficult process, and if produced without refining steps, the productivity is enhanced and it is very beneficial industrially.

Herein, formed products include screws, bolts, nuts, shafts, rivets, pins, stud bolts, fasteners, gears, shaft parts, springs, and other machine parts (Structural steels for machines, by Toshiyuki Watanabe, published by Japan Iron and Steel Society, p. 46, p. 97).

Recently, in the field of screws and bolts, it is possible to product without refining steps in JIS strength classification of up to 8.8. In the case of production without refining, it is required to enhance strength of the material itself, and alloying elements such as Cr, Ti, Nb, or B are added to the material. However, addition of alloying elements often lowered the toughness of formed product, and was not always preferred means. In JIS strength classification of up to 8.8, however, most screws and bolts are now produced by conventional method including refining steps. As the production method for high strength screws and bolts having a tensile strength of 800 MPa or more, the refining process by hardening and tempering is indispensable.

The invention is devised in the light of the above background, and it is hence a primary object thereof to solve the problems of the prior art, and present a formed product of high strength holding the strength by ultra fine structure without resort to addition of alloying elements or refining steps, for example, pressed product, various parts and members, and a method for production capable of producting such formed product of high strength, such as screws and bolts, easily.

### DISCLOSURE OF THE INVENTION

To solve the above problems, the invention presents the following.

It is a first aspect of the invention to present a formed product characterized by having an ultra fine structure comprising ferrite grains of average grain diameter of 3 μm or less, and it is a second aspect to present a formed product characterized by using a steel having an ultra fine structure comprising ferrite grains of average grain diameter of 3 μm or less as raw material, and being produced by a forming step only, not followed by refining steps.

Herein, the ultra fine structure comprising ferrite grains is a structure mainly comprising ferrite grains. In this sense, the ultra fine structure comprising ferrite grains may be either single phase structure of ferrite grains only, or may include a second phase of carbide, pearlite, martensite, or austenite. Further, fine carbonitrides and other precipitates may be included.

It is a third aspect of the invention to present a formed product characterized by having an ultra fine structure comprising elongated ferrite grains of average grain diameter of shorter diameter of 3 μm or less, it is a fourth aspect to present a formed product characterized by using a steel having an ultra fine structure comprising elongated ferrite grains of average grain diameter of shorter diameter of 3 μm or less as raw material, and being produced by a forming step only, not followed by refining steps, it is a fifth aspect to present a formed product in the composition by wt. % of

C: 0.001% or more, 1.2% or less,

Si: 2% or less,

Mn: 3% or less,

P: 0.2% or less,

S: 0.1% or less,

Al: 0.3% or less,

N: 0.02% or less,

and a balance of Fe and inevitable impurities, and it is a sixth aspect to present a formed product of any one of the above products having Vickers hardness of 200 or more.

It is a seventh aspect of the invention to present a production method for a formed product without refining treatments comprising using a steel having an ultra fine structure comprising ferrite grains of average grain diameter of 3 μm or less as raw material, and forming only, not followed by refining, it is an eighth aspect to present a production method for a formed product in which using a steel having an ultra fine structure comprising ferrite grains of average grain diameter of 1 μm or less as raw material, and it is a ninth aspect to present a production method for a formed product without refining treatments comprising using a steel having an ultra fine structure comprising elongated ferrite grains of shorter grain diameter of 3 μm or less as raw material, by warm working or cold working of a material having ultra fine structure, and forming only, not followed by refining.

It is a tenth aspect of the invention to present a screw or bolt characterized by having an ultra fine structure comprising ferrite grains of average grain diameter of 1 μm or less, it is an eleventh aspect to present a screw or bolt characterized by using a steel having an ultra fine structure comprising ferrite grains of average grain diameter of 1 μm or less as raw material, and being produced by a forming step only, not followed by refining steps, it is a twelfth aspect to present a screw or bolt of high strength characterized by having a strength of 8.8 or more in JIS strength classification, it is a thirteenth aspect to present a production method for a screw or bolt without refining treatments comprising using a steel having an ultra fine structure comprising ferrite grains of average grain diameter of 1 μm or less as raw material, and forming only by at least one process of cold working and warm working, not followed by refining steps, and it is a fourteenth aspect to present a production method for a screw or bolt in which using a steel having an ultra fine structure comprising ferrite grains of average grain diameter of 0.7 μm or less as raw material.

It is a fifteenth aspect to present a screw or bolt characterized by having an ultra fine structure comprising elongated ferrite grains of average grain diameter of shorter diameter of 1 μm or less, it is a sixteenth aspect to present a screw or bolt characterized by using a steel having an ultra fine structure comprising elongated ferrite grains of average grain diameter of shorter diameter of 1 μm or less as raw material, and being produced by a forming step only, not followed by refining steps, and it is a seventeenth aspect to present a production method for a screw or bolt, characterized by using a steel having an ultra fine structure comprising elongated ferrite grains of grain diameter shorter diameter of 3 μm or less as raw material, by warm working or cold working of material having ultra fine structure, and being produced by a forming step only, not followed by refining steps.

The present inventors have been studying intensively for years about miniaturization of crystal grains of ferrite steel. Miniaturization of crystal grain is a method of raising the strength of steel material only by miniaturization of crystal grains, without adding alloying elements, and it is the only method capable of enhancing the toughness at the same time. It has been hence known to be the most ideal strength increasing method in steel materials.

Recently, inventors of the invention have accomplished to make the crystal grains as ultra fine as 0.5 mm, which far exceeds the limit of the conventional fine size about 5 mm (Japanese Patent Application Laid-Open (JP-A) No. 11-315342, (JP-A) No. 2000-309850, and (JP-A) No. 2002-54670). By applying the ultra fine structure technology of crystal grains in the material of high strength pressed product, it is expected that an enough enhancement of strength can be realized, and thereby reaching the present invention.

This time, as a result of additional intensive studies, if the ferrite grains are elongated in one direction, it has been found that pressed products, parts and members of various kinds can be obtained as high strength material and high strength formed product, by controlling the shorter diameter. This discovery is very beneficial for production technology.

In the case of machine screws of which screw shaft diameter is 2.0 mm or less, heat treatment such as hardening may be difficult due to the residual stress after hardening or relation between hardening depth and screw diameter or screw thread size in case of carburizing and quenching. The method of the invention is very effective when desired to obtain a member of high strength in spite of such small size.

### BRIEF DESCRIPTION OF THE DRAWINGS

FIG. 1 is a diagram showing the relation of ferrite grain diameter and tensile strength.

FIG. 2 is a photograph showing the appearance of steel bar of ultra fine structure of average grain diameter of 1 μm or less and SEM image.

FIG. 3 is a photograph showing the top view and side view of pressed product produced in an embodiment.

FIG. 4 (a) is a photograph of pressed product of the invention, and (b) is a photograph of sectional structural view of pressed part of a conventional pressed product.

FIG. 5 is a photograph of appearance of an example of embodiment.

### BEST MODE FOR CARRYING OUT THE INVENTION

The invention has the features as described above, and its preferred embodiments are described below.

The formed product of high strength presented by the invention is essentially made of a steel material having an ultra fine structure comprising ferrite grains having an average grain diameter of 3 μm or less. It is also characterized by having an ultra fine structure of ferrite grains of average shorter diameter of 3 μm or less. It has not been assumed at all for the formed product to have such ultra fine structure of ferrite grains, and it is realized for the first time in the present invention.

Steel having an ultra fine structure comprising ferrite grains having an average grain diameter of 3 μm or less as raw material is not particularly specified in production method or composition. The raw material may be cold worked or warm worked, and ferrite grains may be elongated.

Preferably, the material may be bar or wire material made from thick steel plate having an ultra fine structure proposed by the present inventors (JP-A No. 2002-54670). That is, by introducing a strain larger than a certain critical strain by applying multi-directional and multi-pass pressing in warm working temperature region to thick steel plate, a steel material having a supercritical structure of average grain diameter of 1 μm or less can be used. In the steel having such ultra fine structure, for example, high strength is realized by pulverization of crystal grains, without making use of strength enhancing mechanism by phase transformation. Accordingly, the pressed product made of such steel material can be produced without any refining steps of carburizing, hardening, or tempering, and can be presented as a formed product of high strength.

The high strength of the formed product of high strength in the invention may be defined as Vickers hardness of 200 or more at ferrite grain average diameter of 3 μm or less.

In the aspect of composition, since strength enhancing mechanism by phase transformation is not utilized at all, addition of alloying elements for enhancing the strength is not needed, and the steel composition is not limited at all, and steel materials of wide range of composition may be used, such as ferrite single phase steel, austenite single phase steel, and other types of steel free from phase transformation. A specific example is a composition by wt. % of

C: 0.001% or more, 1.2% or less,

Si: 2% or less,

Mn: 3% or less,

P: 0.2% or less,

S: 0.1% or less,

Al: 0.3% or less,

N: 0.02% or less,

Cr, Mo, Cu, Ni: 5% or less in total,

Nb, Ti, V: 0.5% or less in total,

B: 0.01% or less,

and a balance of Fe and inevitable impurities. These alloying elements Cr, Mo, Cu, Ni, Nb, Ti, V, B may be contained more than the specified range as required, or may not be contained at all.

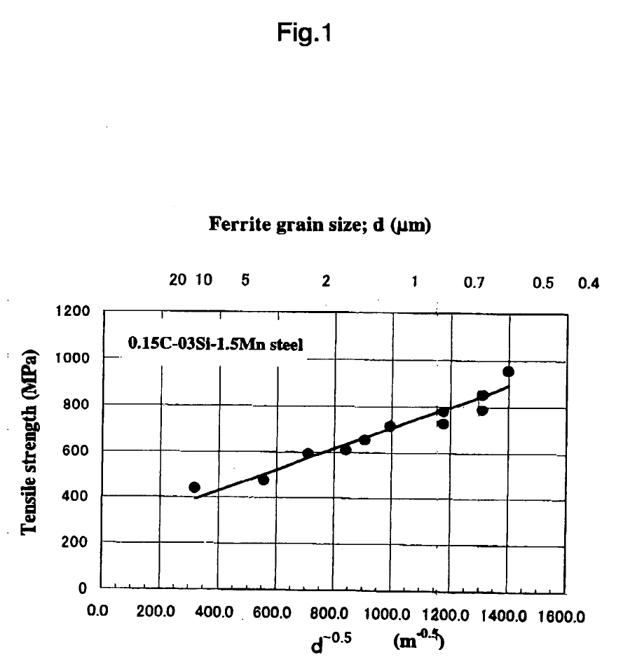

A screw of high strength of the invention is described below, and, for example, a high strength screw mainly comprising 0.15% C-0.3Si-1.5% Mn may be realized by tensile strength of 700 MPa at ferrite average grain diameter of 1.0μ, or 800 MPa at 0.7 μm as shown in FIG. 1. As high strength screw sufficiently satisfying the strength of 8.8 or more in JIS strength classification, the average grain diameter of 0.7 μm or less may be presented. These values are only examples, and screws of higher strength can be presented in screws of different composition.

In the invention, the average grain diameter of ferrite grains is defined by the cutting method in ferrite crystal grain testing method in JIS G0552, and the shorter diameter is the grain diameter of vertical section of an elongated grain.

The production method for high strength formed product of the invention is characterized by the process of forming step only such as pressing, without being accompanied by refining steps, by using a steel material having an ultra fine structure of ferrite grains having an average shorter diameter of 3 μm or less, in particular, ferrite grains having a shorter diameter of 3 μm or less.

The forming means is not particularly specified, and any known method may be employed depending on the desired standard and shape, such as pressing, forging, cutting, or header forming or thread rolling in the case of screws. More specifically, using a bar or wire material of a steel having an ultra fine structure, the leading end of the material is processed to form a head of pressed piece, cut to a specified length, and pressed to form a pressed screw part.

By using a steel having an ultra fine structure as the material, the present inventors discovered that a pressed product of at least Vickers hardness of 200 or more, or further JIS strength classification of 8.8 or more (at least Vickers hardness of 250 or more) can be easily produced without requiring refining steps. That is, without requiring refining steps such as carburizing, hardening or tempering, formed product, pressed product, part or member of high strength having high core strength, tensile stress, and shearing stress can be produced.

The invention is more specifically described below while referring to exemplary embodiments.

### EMBODIMENTS

### Embodiments 1 to 4

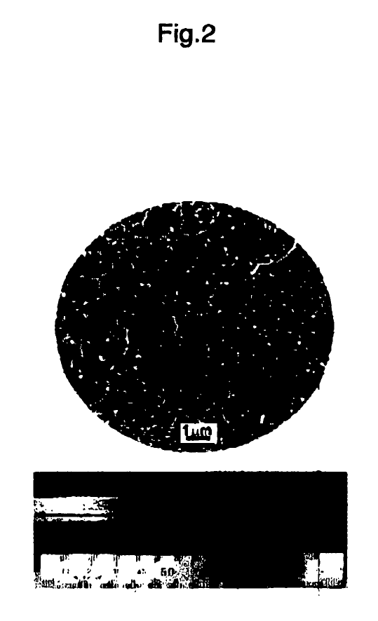

By melting a steel material having chemical composition as shown in Table 1, and introducing a strain larger than a critical strain in warm working temperature region, a steel bar having an ultra fine structure of average grain diameter of 1 μm or less was prepared. The appearance image of the steel material and its scanning electron microscope (SEM) image are shown in FIG. 2.

TABLE 1

| | [mass %] | | | | | | |
|---|---|---|---|---|---|---|---|
| | C | Si | Mn | P | S | s.Al | N |
| 1 | 0.05 | 0.3 | 1.0 | 0.01 | 0.001 | 0.031 | 0.002 |
| 2 | 0.10 | 0.3 | 1.0 | 0.01 | 0.001 | 0.031 | 0.002 |
| 3 | 0.15 | 0.3 | 1.0 | 0.01 | 0.001 | 0.031 | 0.002 |
| 4 | 0.30 | 1.0 | 1.0 | 0.01 | 0.001 | 0.031 | 0.002 |
| 5 | 0.45 | 0.3 | 1.0 | 0.01 | 0.001 | 0.031 | 0.002 |
| 6 | 0.76 | 0.3 | 1.0 | 0.01 | 0.001 | 0.031 | 0.002 |
| 7 | 0.16 | 0.1 | 0.8 | 0.01 | 0.001 | 0.031 | 0.002 |
| (SWCH16A) | | | | | | | |

This steel having an ultra fine structure was formed into a wire material of φ1.3 mm in diameter, and the leading end was formed to form a screw head, cut to a specified length, and rolled to form a screw head, and a cross recessed pan head machine screw of M1.6 was produced (embodiments 1 to 4).

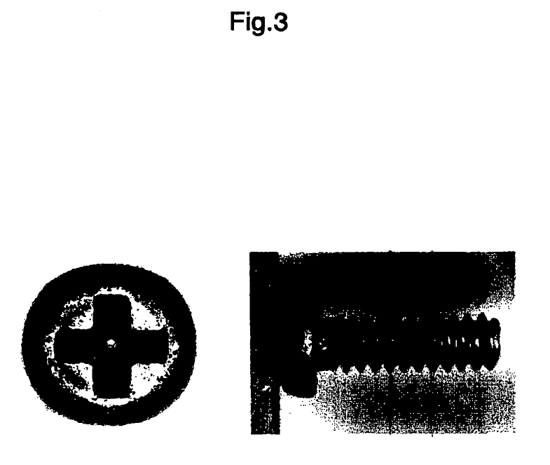

Top view and side view of obtained screw are shown in FIG. 3. By way of comparison, using chemical compositions 3 and 7 in Table 1, wire materials of ferrite grain diameter of 20 μm were used, and screws were produced similarly (comparative examples 1, 2). Using chemical composition 7 in Table 1, the material was formed, and refined by conventional method by hardening and tempering, and a screw was produced.

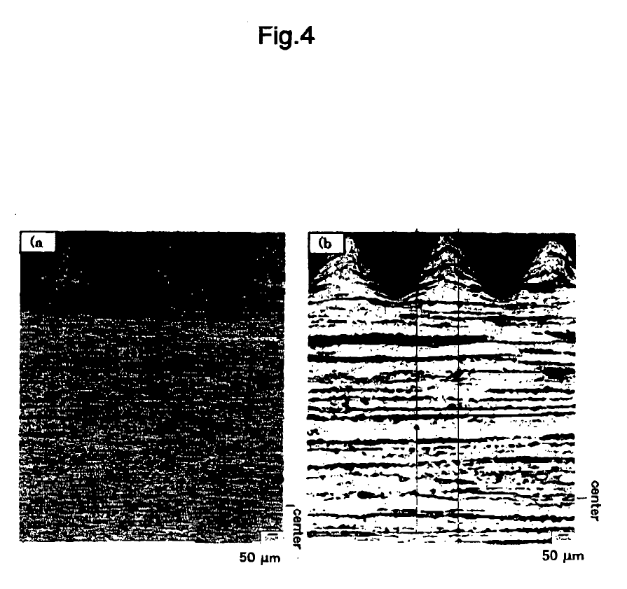

In these screws, the ferrite grain diameter of structure, tensile strength, and screw core strength were measured, and results are shown in Table 2. In the screws of embodiment 1 and comparative example 1, screw sectional images are shown in FIG. 4 (a), (b), respectively.

TABLE 2

| | | | | Ferrite | | |
|---|---|---|---|---|---|---|
| | | Shape | | grain | | |
| | | of | | di- | Tensile | Screw |
| | Compo- | formed | Heat | ameter | strength | core |
| | sition | product | treatment | (μm) | (MPa) | strength |
| Embodiment | 3 | Screw | None | 0.7 | 807 | 269 |
| 1 | | | | | | |
| Embodiment | 2 | Screw | None | 0.5 | 843 | 281 |
| 2 | | | | | | |
| Embodiment | 3 | Screw | None | 1.0 | 700 | 233 |
| 3 | | | | | | |
| Embodiment | 1 | Screw | None | 0.5 | 800 | 266 |
| 4 | | | | | | |
| Comparative | 3 | Screw | None | 20 | 546 | 182 |
| example 1 | | | | | | |
| Comparative | 7 | Screw | None | 20 | 492 | 164 |
| example 2 | | | | | | |
| Comparative | 7 | Screw | Quenching | Marten- | 730 | 242 |
| example 3 | | | and | site | | |
| | | | tempering | | | |

Screws of comparative examples 1, 2 not refined by hardening and tempering did not reach the Vickers hardness of 190, while the screws of embodiments 1, 2, 4 exceeded the Vickers hardness of 250, and even embodiment 3 had a high hardness exceeded 230. This hardness is same or higher than that of the conventional refined screw of comparative example 3.

As known from FIG. 4, the high strength screw of embodiment 1 of the invention has a very fine structure as compared with the screw of comparative example 1. In the high strength screw of embodiment 1, it was completely free from martensite structure possibly caused by hardening.

Hence, the screws of the invention are proved to have a high strength because of the ultra fine structure, without requiring refining steps.

The invention is not limited to these embodiments alone, but may be changed and modified in various forms.

### Embodiments 5 to 9

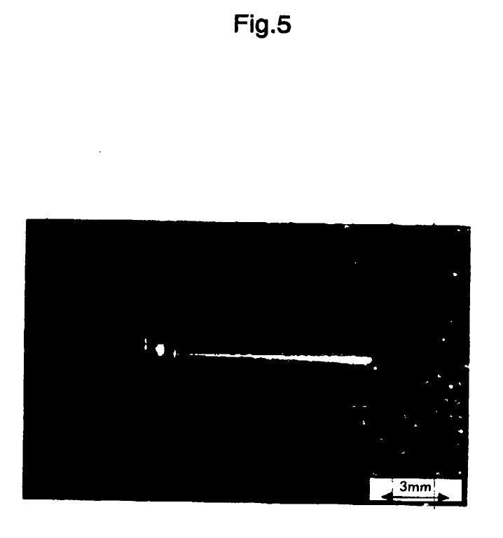

Using a wire material of φ8 mm in diameter of a steel having an ultra fine structure in the composition in Table 1, the leading end was formed to form a bolt head, cut to a specified length, and rolled to form M8 bolts (embodiments 5, 7, 8). Using a wire material of φ3 mm in diameter of a steel having an ultra fine structure, the leading end was formed to form a head, cut to a specified length, and produced into rivets (embodiments 6, 9). FIG. 5 is a photograph showing the appearance of embodiment 6.

By way of comparison, using chemical compositions shown in Table 1, wire materials of ferrite grain diameter of 20 μm were used, and bolts and rivets were produced similarly (comparative examples 4 to 6). Using chemical composition 7 in Table 1, the material was cold formed, and refined by conventional method by hardening and tempering.

In these pressed products, the ferrite grain diameter of structure, tensile strength, and core hardness were measured, and results are shown in Table 3.

TABLE 3

| | | | | Ferrite | | |
|---|---|---|---|---|---|---|
| | | Shape | | grain | | |
| | | of | | di- | Tensile | Vickers |
| | Compo- | formed | Heat | ameter | strength | hard- |
| | sition | product | treatment | (μm) | (MPa) | ness |
| Embodiment | 3 | Bolt | None | 0.6 | 810 | 275 |
| 5 | | | | | | |
| Embodiment | 3 | Rivet | None | 0.5 | | 285 |
| 6 | | | | | | |
| Embodiment | 4 | Bolt | None | 2.5 | 600 | 205 |
| 7 | | | | | | |
| Embodiment | 1 | Bolt | None | 1 | 700 | 235 |
| 8 | | | | | | |
| Embodiment | 6 | Rivet | None | 0.7 | | 340 |
| 9 | | | | | | |
| Comparative | 7 | Bolt | None | 20 | 546 | 182 |
| example 4 | | | | | | |
| Comparative | 3 | Rivet | None | 20 | | 164 |
| example 5 | | | | | | |
| Comparative | 3 | Bolt | Quenching | Marten- | 730 | 242 |
| example 6 | | | and | site | | |
| | | | tempering | | | |

Cold pressed bolts of comparative examples 4, 5 not refined by hardening and tempering did not reach the Vickers hardness of 190, while the formed products of embodiments 5 to 9 exceeded the Vickers hardness of 200, and in particular embodiments 5, 6, 9 exceeded 250. This hardness is same or higher than that of the conventional refined pressed product of comparative example 6.

In the high strength formed products of embodiments 5 to 9, it was completely free from martensite structure possibly caused by hardening.

Hence, the pressed products of the invention are proved to have a high strength because of the ultra fine structure, without requiring refining steps.

The invention is not limited to these embodiments alone, but may be changed and modified in various forms.

### INDUSTRIAL APPLICABILITY

As described specifically herein, the invention presents a high strength formed product having high hardness and high toughness by the ultra fine structure, without resort to addition of alloying elements or refining steps, and also a production method for high strength formed product capable of producting the same easily.

1. A formed product having an ultra fine structure comprising ferrite grains of average grain diameter of 3 μm or less.

2. A formed product according to claim 1 comprising a steel having an ultra fine structure comprising ferrite grains of average grain diameter of 3 μm or less as raw material, and being produced by a forming step only, not followed by refining steps.

3. A formed product comprising an ultra fine structure comprising elongated ferrite grains of average grain diameter of shorter diameter of 3 μm or less.

4. A formed product according to claim 3 comprising a steel having an ultra fine structure comprising elongated ferrite grains of average grain diameter of shorter diameter of 3 μm or less as raw material, and being produced by a forming step only, not followed by refining steps.

5. The formed product as in claims 1 to 4, wherein the composition is, by wt. %, of
C: 0.001% or more, 1.2% or less,
Si: 2% or less,
Mn: 3% or less,
P: 0.2% or less,
S: 0.1% or less,
Al: 0.3% or less,
N: 0.02% or less,
and a balance of Fe and inevitable impurities.

6. The formed product as in claims 1 to 4, wherein the Vickers hardness is 200 or more.

7. A production method for a formed product without refining treatments comprising using a steel having an ultra fine structure comprising ferrite grains of average grain diameter of 3 μm or less as raw material, and forming only, not followed by refining.

8. The production method for a formed product of claim 7, which comprises employing a steel having an ultra fine structure comprising ferrite grains of average grain diameter of 1 μm or less as raw material.

9. A production method for a formed product without refining treatments comprising employing a steel having an ultra fine structure comprising elongated ferrite grains of shorter grain diameter of 3 μm or less as raw material, by warm working or cold working of a material having ultra fine structure, and forming only, not followed by refining.

10. A screw or bolt having an ultra fine structure comprising ferrite grains of average grain diameter of 1 μm or less.

11. A screw or bolt according to claim 10 comprised of a steel having an ultra fine structure comprising ferrite grains of average grain diameter of 1 μm or less as raw material, and being produced by a forming step only, not followed by refining steps.

12. The screw or bolt of high strength of claim 10 or 11, having a strength of 8.8 or more in JIS strength classification.

13. A production method for a screw or bolt without refining treatments comprising employing a steel having an ultra fine structure comprising ferrite grains of average grain diameter of 1 μm or less as raw material, and forming only by at least one process of cold working and worm working, not followed by refining steps.

14. The production method for a screw or bolt of claim 13, in which using a steel having an ultra fine structure comprising ferrite grains of average grain diameter of 0.7 μm or less as raw material.

15. A screw or bolt having an ultra fine structure comprising elongated ferrite grains of average grain diameter of shorter diameter of 1 μm or less.

16. A screw or bolt according to claim 15 comprising a steel having an ultra fine structure comprising elongated ferrite grains of average grain diameter of shorter diameter of 1 μm or less as raw material, and being produced by a forming step only, not followed by refining steps.

17. A production method for a screw or bolt, which comprises employing a steel having an ultra fine structure comprising elongated ferrite grains of grain diameter shorter diameter of 3 μm or less as raw material, by warm working or cold working of material having ultra fine structure, and being produced by a forming step only, not followed by refining steps.
